(19) United States
(12) Patent Application Publication
(10) Pub. No.: US 2007/0048067 A1
(43) Pub. Date: Mar. 1, 2007

(54) Writing Instrument Comprising Plastically Deformable Member

(76) Inventors: Matthew J. Gerules, Chicago, IL (US); Jason S. Silverstein, Chicago, IL (US); John F. Travers, Plainfield, IL (US); Nicholas M. Nanos, Lake in the Hills, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/466,061

(22) Filed: Aug. 21, 2006

Related U.S. Application Data
(60) Provisional application No. 60/710,411, filed on Aug. 22, 2005.

(51) Int. Cl. B43K 29/00

(52) U.S. Cl. 401/195

(57) ABSTRACT

A writing instrument comprises a body, a writing tips and at least one plastically deformable member. The body contains a writing medium. The writing tip extends from the body. The at least one plastically deformable member extends from the body and is adapted to be arranged in a plurality of different configurations. An accessory for a writing instrument comprises a cap and at least one plastically deformable member. The cap is adapted to be removably attached to a writing instrument. The at least one plastically deformable member is attached to the cap and adapted to be bent into a plurality of configurations to customize the appearance of the cap and/or writing instrument.

### CROSS-REFERENCE TO RELATED APPLICATIONS

This application is based on and claims the benefit of priority of U.S. Provisional Patent Application No. 60/710,411, filed Aug. 22, 2005, the entire contents of which are hereby expressly incorporated herein by reference.

### FIELD OF THE DISCLOSURE

The present disclosure generally relates to writing instruments and, more particularly, to writing instruments comprising plastically deformable members.

### BACKGROUND

Most pens and pencils, for example, include a body containing a writing medium such as ink or lead, a writing tip, a storage clip, and an optional eraser. Typical storage clips are constructed of either metal or plastic and include a flange-like member extending parallel to the body of the instrument. Metal clips can sometimes be removed from the writing instrument, but plastic clips are typically fixed to the pen.

Accordingly, the typical storage clip is very utilitarian and only seems to work when storing the writing instrument inside of a pocket or sleeve particularly designed for instrument storage of some sort. Additionally, such typical school and office supplies provide no opportunity for one to express his/her creative self.

### SUMMARY

One aspect of the present disclosure comprises a writing instrument. The writing instrument comprises a body, a writing tip, and at least one plastically deformable member. The body contains a writing medium. The writing tip extends from the body and is adapted to enable a user to write messages, draw pictures, etc. The at least one plastically deformable member also extends from the body and is adapted to be arranged in a plurality of different configurations to thereby enable a user to entertain and/or creatively express his/herself, or secure the writing instrument to an article.

According to another aspect, a cap is disposed on the body and the at least one plastically deformable member extends from the cap.

According to another aspect, the at least one plastically deformable member comprises a plurality of plastically deformable members of substantially equal length.

According to yet another aspect, the at least one plastically deformable member comprises a wire member coated in plastic.

According to yet another aspect, a design is provided on the body of the writing instrument.

According to still another aspect, a design is provided on the at least one plastically deformable member.

According to still another aspect, at least a portion of a character is provided on the body such that the at least one plastically deformable member comprises a characteristic of the character. In one aspect, the at least one plastically deformable member comprises hair of the character.

According to still yet another aspect, a plurality of additional plastically deformable members extend from the at least one plastically deformable member.

According to a still further aspect, the at least one plastically deformable member is adapted to be secured to an article such as a book bag, a notebook, etc.

According to still a further aspect, the at least one plastically deformable member is rotatably secured to the body of the sting instrument to provide for a generally free range of rotational motion, thereby reducing the possibility of the plastically deformable member braking.

A still further aspect of the present disclosure comprises an accessory for a writing instrument. The accessory comprises a cap and at least one plastically deformable member extending from the cap. The cap is adapted to be disposed on a writing instrument such as a pen, a pencil, a marker, etc. The plastically deformable member enables a user to entertain or creatively express oneself and/or to attach the cap and/or the writing instrument to an article such as a book bag, a notebook, etc.

### BRIEF DESCRIPTION OF THE DRAWINGS

FIG. 1 is a perspective view of a writing instrument constructed according to the principles of the present disclosure having a plurality of plastically deformable members arranged according to a first configuration;

FIGS. 2A-2C are perspective views of the writing instrument of FIG. 1 having the plurality of plastically deformable members arranged according to a second, third, fourth, fifth and sixth configurations, respectively;

FIGS. 3A and 3B are partial side views of the writing instrument of FIG. 1 having the plurality of plastically deformable members arranged in fifth and sixth configurations, respectively;

FIGS. 4A and 4B are perspective views of the writing instrument of FIG. 1 having the plurality of plastically deformable members arranged to secure the writing instrument to a book bag and a notebook, respectively;

FIG. 5 is a partial cross-sectional side view of the writing instrument of FIG. 1 showing one embodiment of an end cap and lock ring arrangement;

FIG. 6 is a perspective view of an alternative embodiment of a writing instrument constructed according to the principles of the present disclosure having a single plastically deformable member including a portion of a character provided thereon and arranged in a first configuration;

FIGS. 7A and 7B are partial side views of the writing instrument of FIG. 6 having the single plastically deformable member arranged in second and third configurations, respectively;

FIG. 8 is a perspective view of a writing instrument constructed according to the principles of the present disclosure similar to that of FIGS. 6 and 7 and having a single plastically deformable member including an additional plurality of plastically deformable members extending therefrom and arranged in a first configuration;

FIGS. 9A-9D are partial side views of the writing instrument of FIG. 8 having the additional plastically deformable members arranged in second, third, fourth, and fifth configurations, respectively;

FIG. 10 is a partial cross-sectional side view of the writing instrument of FIG. 6 including an alternative end cap and lock ring arrangement; and

FIG. 11 is a detailed cut-away view of the end cap of FIG. 10 taken from circle XI of FIG. 10 with the lock ring removed therefrom.

### DETAILED DESCRIPTION

The present disclosure provides a writing instrument and/or a cap for a writing instrument having a plastically deformable member or a plurality of plastically deformable members extending therefrom. In one embodiment, the plastically deformable member(s) is coupled to the non-writing end of the writing instrument. In another embodiment, the plastically deformable member(s) is coupled to a removable cap of the writing instrument. The plastically deformable member(s) provide an individual such as a student an opportunity to creatively express and/or entertain his/herself, as well as a mechanism to easily and conveniently store, transport, and/or display the writing instrument. Specifically, the plastically deformable member(s) may be bent and arranged in a multitude of configurations. This bendable feature further enables the individual to attach the writing instrument to a loop on a book bag or notebook for easy transportation or display, thereby eliminating the need for a specifically designed pocket for storing the writing instrument) as well as introducing a fun way to display the individual's creativity.

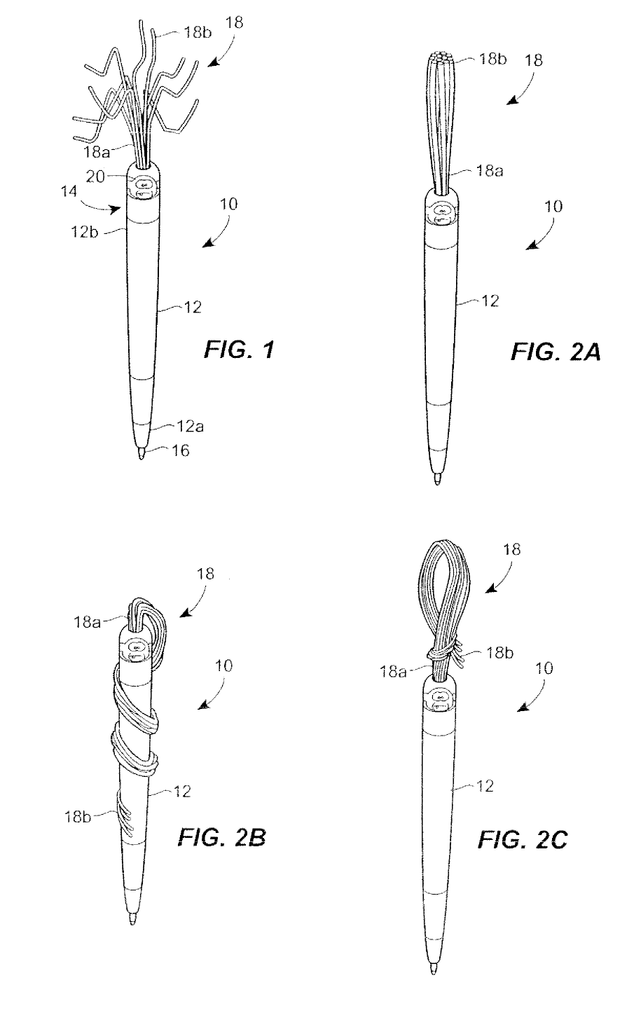

FIG. 1 depicts a writing instrument 10 constructed according to the principles of the present disclosure. The writing instrument 10 includes a body 12, an end cap 14, a writing tip 16 for dispensing a writing medium, and a plurality of plastically deformable members 18. In the form depicted, the plastically deformable members 18 are bendable to allow a user to manipulate them between various configurations. So constructed, the writing instrument 10 enables a user to entertain and/or creatively express his/herself, or to secure the writing instrument to an article, as will be described below.

More specifically, the body 12 of the writing instrument 10 includes a first end 12a and a second end 12b. The end cap 14 is disposed on the second end 12b. The plurality of plastically deformable members 18 generally comprise metal wires coated in plastic and attached to and extending from the end cap 14. In one embodiment, the plurality of plastically deformable members 18 comprise a malleable zinc or aluminum wire coated with a soft plastic such as a thermoplastic elastomer.

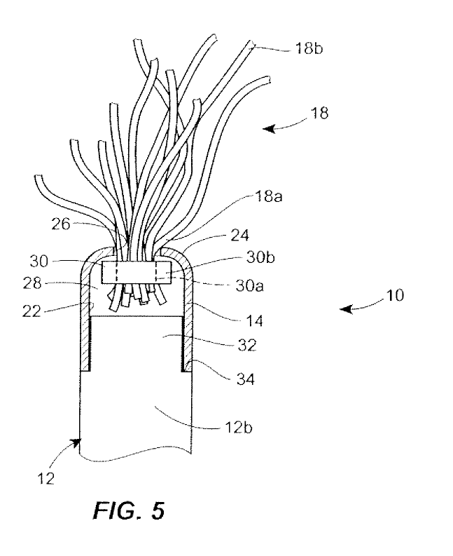

As depicted in FIG. 5, each of the plurality of plastically deformable members 18 includes a secured end 18a and a free end 18b. In one embodiment, the plastically deformable members 18 are of substantially the same length and constructed of different colors. The writing tip 16 is in fluid communication with an ink cartridge contained within the body 12 and protrudes through an orifice (not shown) in the first end 12a to enable a user to write messages, draw pictures, etc.

In an exemplary embodiment depicted in FIG. 1, the writing instrument 10 comprises an end cap 14 having a design 20. The design 20 illustrated in FIG. 1 comprises a portion of a character such as a monkey's face. However, in an alternative embodiment, the design may comprise a complete character such as a cartoon character including, but not limited to, a cartoon person or cartoon animal, or any combination thereof or variation thereon. In yet another embodiment, the design 20 may include a textual or graphical design including, but not limited to, an image, indicia, graphics, alphanumerical or numerical symbols, words, phrases, etc. The design 20 may be provided by a sticker disposed on the end cap 14, it may be printed on the end cap 14, or even integrally molded with the end cap 14.

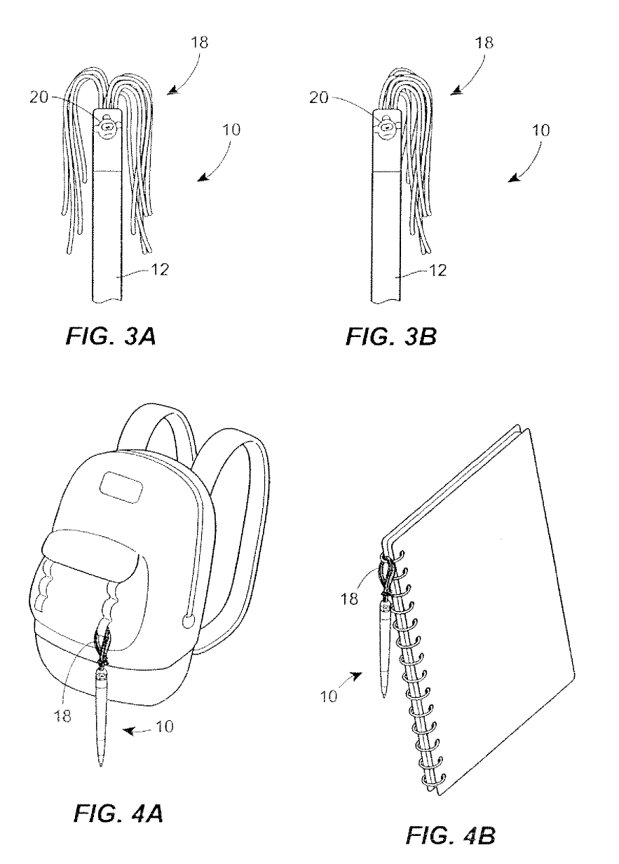

As mentioned, the design 20 of the illustrated embodiment includes a portion of a character, namely, a monkey's face. Therefore, in the disclosed form of the writing instrument 10, the plurality of plastically deformable members 18 resemble a characteristic of the character, namely, hair on the monkey's head. As shown in FIGS. 1 and 2A-2E, the hair may be arranged in a variety of configurations, thereby giving the monkey a variety of appearances. For example, FIG. 1 depicts each of the plurality of plastically deformable members 18 bent to resemble radiating lightning-bolts, thereby giving the monkey in the design 20 the appearance that he/she is experiencing an electric shock. FIG. 2A depicts the plurality of plastically deformable members 18 extending vertically upward from the monkey's head, thereby appearing as though the monkey is falling. FIG. 3A illustrates the monkey as having pigtails. FIG. 3B illustrates the monkey as having a side ponytail. Thus, the plurality of plastically deformable members 18 enable a user to entertain his/herself by customizing the appearance of the writing instrument in conjunction with the design 20.

In still another embodiment, although the writing instrument 10 includes a design 20, a user may choose to arrange the plurality of plastically deformable members 18 into configurations that lack any connection to the design 20 whatsoever. For example, in FIG. 2B, the plurality of plastically deformable members 18 are wrapped down the length of the body 12 of the writing instrument 10. In FIG. 2C, the plurality of plastically deformable members 18 are wrapped to form a loop above the second end 12b of the writing instrument 10. More specifically, in FIG. 2C, the plurality of plastically deformable members 18 are arranged such that the free ends 18b are disposed adjacent to the secured ends 18a. Additionally, the free ends 18b are wrapped around the secured ends 18a to retain the shape of a loop.

The plurality of plastically deformable members 18 can be utilized to attach the writing instrument 10 to an article. For example, the plurality of plastically deformable members 18 may be configured in the shape of the loop illustrated in FIG. 2C such that the plurality of plastically deformable members 18 secure the writing instrument 10 to an article. FIG. 4A illustrates the plurality of plastically deformable members 18 configured and wrapped through a strap on a book bag, thereby securing the writing instrument 10 for transportation and/or display. Additionally, FIG. 4B illustrates the plurality of plastically deformable members 18 configured and wrapped through the binder of a wire-bound notebook. Thus, the plurality of plastically deformable members 18 of the embodiment depicted in FIGS. 4A and 4B enable a user to secure the writing instrument 10 to an article without utilizing a pockets sleeve or other such configuration adapted to store a writing instrument and to which a conventional storage clip is normally attached. Rather, the plastically deformable members 18 provide a user with a creative and expressive way to store, transport and display the writing instrument 10.

As mentioned above with reference to FIG. 1, one embodiment of the writing instrument 10 comprises an end cap 14. FIG. 5 depicts one embodiment of the end cap 14, the plurality of plastically deformable members 18, and the body 12 of the writing instrument 10. The end cap 14 comprises a generally hollow cylindrical member having an inner surface 22, an annular shoulder 24 and an orifice 26. The inner surface 22 defines a cavity 28. The secured ends 18a of the plurality of plastically deformable members 18 are disposed in the cavity 28 of the end cap 14 such that the free ends 18b are disposed outside of the end cap 14. FIG. 5 depicts the free ends 18b partially cut-away for simplicity and it should be understood that the length of the plastically deformable members 18 can be varied. The secured ends 18a of the plurality of plastically deformable members 18 depicted in FIG. 4 are bound together with a lock ring 30. The lock ring 30 includes a through-bore 30a, which compresses the secured ends 18a of the plurality of plastically deformable members 18 together in a bundle. This compression retains the plurality of plastically deformable members 18 in the lock ring 30. In one embodiment, the lock ring 30 comprises an elastically deformable ring. In alternative embodiments, the lock ring 30 may include a heat shrinkable ring, a rigidly lockable ring, or any other device for securing the plurality of plastically deformable members 18 together.

The lock ring 30 includes an outer surface 30b having a dimension that is larger than an inner dimension of the orifice 26, but smaller than a dimension of the inner surface 22 of the end cap 14. Thus, the lock ring 30 cannot fit through the cap 14, and therefore retains the secured ends 18b of the plurality of plastically deformable members 18 in the cavity 28 of the end cap 14. Additionally, the lock ring 307 as well as the secured ends 18a of the plurality of plastically deformable members 18, is free to rotate within the cavity 28. In one embodiment, the lock ring 30 and secured ends 18a may rotate 180°. In a preferred embodiment, the lock ring 30 and secured ends 18a may rotate 360°. This ability to rotate the plastically deformable members 18 makes it less likely for one or more of the plastically deformable members 18 to be bent and broken. Still further, this rotation adds yet another dimension to the level of entertainment that the plastically deform able members 18 provide to a user. In another embodiment, the plurality of plastically deformable members 18 may be retained in the end cap 14 with an adhesive, an epoxy, or some other type of curable resin. In yet another embodiment, the plurality of plastically deformable members 18 may be integrally formed, via injection molding or extrusion, for example, with the end cap 14 and/or body 12 of the writing instrument 10.

The body 12 has a generally cylindrical shape that is similar to typical writing instruments. The second end 12b of the writing instrument 10 depicted in the embodiment of FIG. 5, however, includes a reduced diameter portion 32 and a shoulder 34. The end cap 14 is disposed on the reduced diameter portion 32 and abutted against the shoulder 34, thereby providing the body 12 and end cap 14 combination with a generally cylindrical shape. In one embodiment, the inner surface 22 of the end cap 14 frictionally engages the reduced diameter portion 32 to retain itself thereon. In another embodiment, the inner surface 22 of the end cap 14 may be adhered to the reduced diameter portion 32. In yet another embodiment, the end cap 14 may be integrally formed with the entire body 12 of the writing instrument 10. For example, the body 12 may be formed with the end cap 14 integral therewith as a single piece. Subsequently, a resin or an epoxy may be injected into the cavity formed in the end cap 14. Prior to the resin curing, the secured ends 18a of the plurality of plastically deformable members 18 may be set into the resin or epoxy for attachment. Thus, the writing instrument 10 is not limited to the construction of the body 12 and end cap 14 depicted and expressly described herein, but rather, includes any device for attachment capable of satisfying the principles of the disclosure.

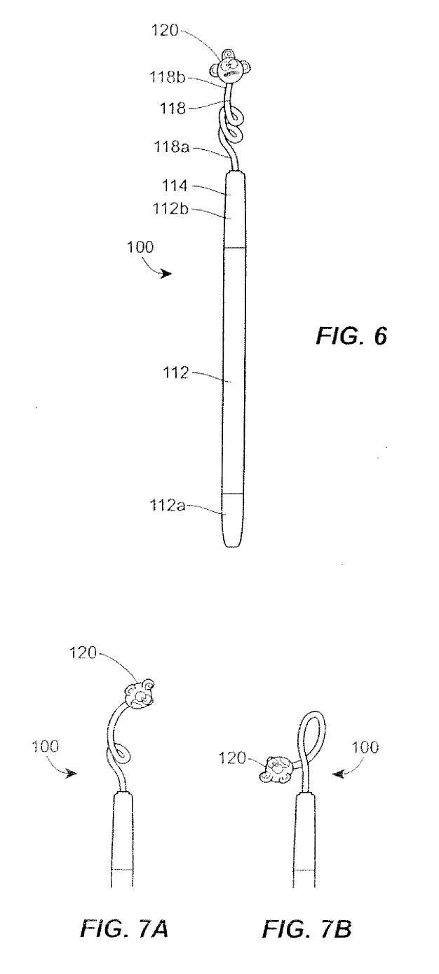

FIG. 6 depicts an alternative writing instrument 100 constructed according to the principles of the present disclosure. The writing instrument 100 includes a body 112, an end cap 114, a writing tip (not shown) for dispensing a writing medium, and a single plastically deformable member 118. In the form depicted in FIG. 6, the plastically deformable member 118 is bendable between various configurations similar to the plastically deformable members 18 described above with reference to FIGS. 1-5. For example, FIG. 6 depicts the plastically deformable member 118 configured in a plurality of upright coils. FIG. 7A depicts the plastically deformable member 118 configured in a single upright coil. FIG. 7B depicts the plastically deformable member 118 configured in a downward loop. Thus, the writing instrument 100 enables a user to entertain and or creatively express his/herself. Additionally, similar to the embodiment described above with reference to FIGS. 4A and 4B, the plastically deformable member 118 may be configured for attachment to a loop of a book bag, notebook or other such article for easy storage, transportation, and/or display.

The body 112 of the writing instrument 100 includes a first end 112a and a second end 112b. The end cap 114 is disposed on the second end 112b, and is removable therefrom. The plastically deformable member 118 includes a secured end 118a, a free end 118b, and a design 120. The design 120 is attached to the free end 118b. The plastically deformable member 118 is generally thicker in diameter than each of the plastically deformable members 18 described above. In one embodiment, the thickness of the plastically deformable member 118 is due to a thicker plastic coating provided onto the metal wire, or alternately by utilizing a heavier gage wire. In one form, the design 120 disposed on the plastically deformable member 118 is integrally formed with the plastically deformable member 118 through an extrusion process, a molding process, or any other process capable of forming such a design 120. Furthermore, in various embodiments, the design 120 is constructed of a material similar to and compatible with the material of the coating on the plastically deformable member 118, or wherein the plastically deformable member 118 lacks a coating, the same material as the plastically deformable member 118 itself.

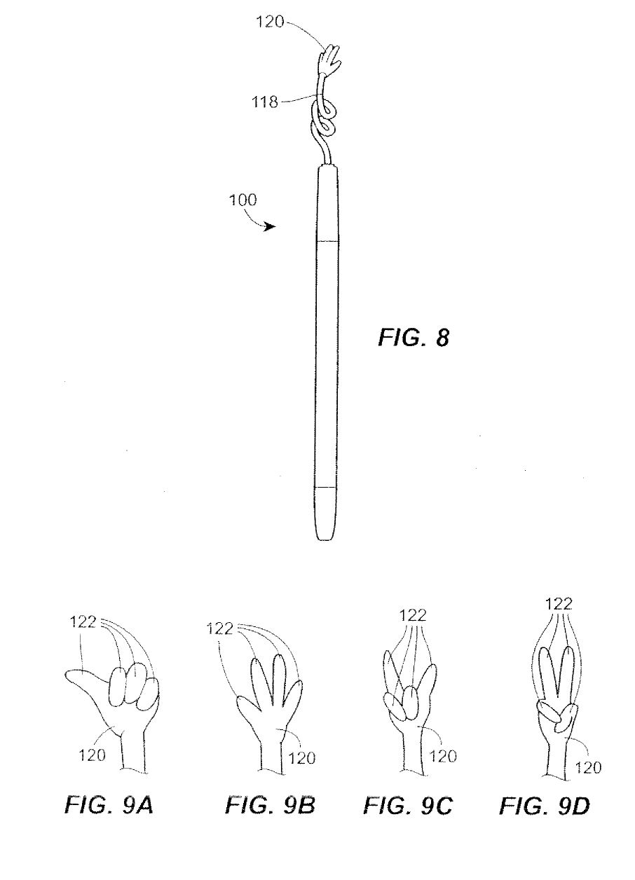

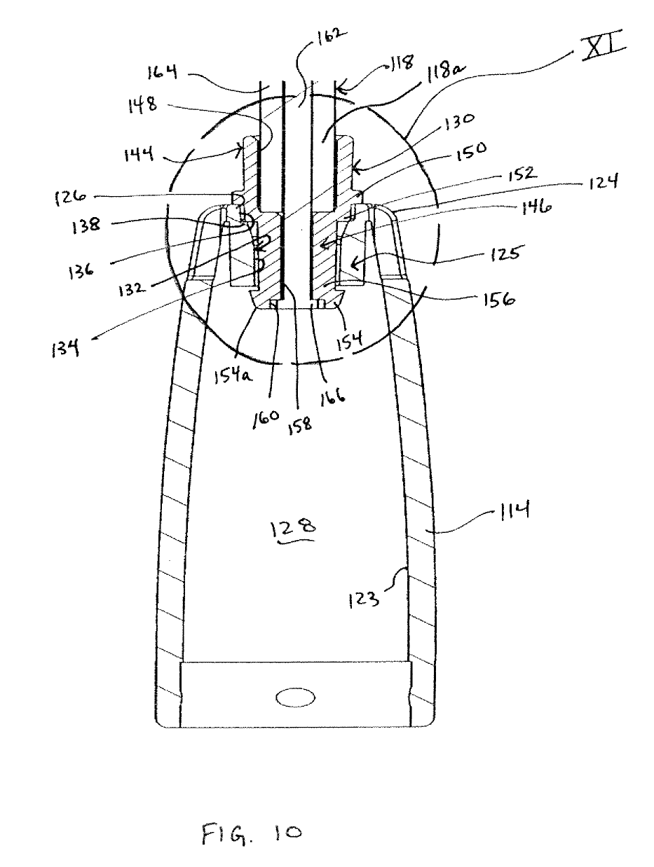

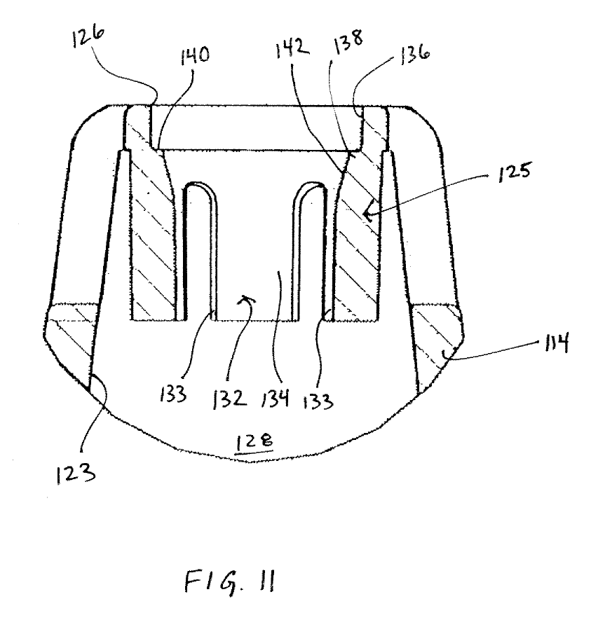

In the embodiment depicted in FIGS. 6 and 7, the design 120 comprises a three-dimensional reproduction of a portion of a character, i.e., a monkey's head. However, in alternative embodiments, the design 120 may comprise an entire character such as an entire cartoon person or animal. In yet other alternative embodiments, the design may not include a character or a portion of a character at all, but rather, an alphanumeric or numeric symbol, a word, a phrase, or any other design that may be desirable to consumers. For example, FIGS. 8 and 9 depict the design 120 as comprising a version of a hand. More specifically, as illustrated in FIG. 9, the design 120 includes a plurality of deformable members 122 representative of fingers on the hand. In the embodiment of FIGS. 8 and 9, each of the plurality of deformable members 22 are constructed of a metal wire coated in plastic, similar to the plastically deformable member 118, and therefore are bendable into a plurality of configurations. For example, FIG. 9A depicts the plurality of plastically deformable members 122 arranged in a thumbs-up configuration. FIG. 9B depicts the plurality of plastically deformable members 122 arranged in a high-five-type configuration. FIG. 9C depicts the plurality of plastically deformable members 122 arranged in a hang-loose configuration. FIG. 9D depicts the plastically deformable members 122 arranged in a peace-sign configuration. Thus, the ability to bend the plastically deformable members 122 of the design 120 in addition to the plastically deformable member 118 provides another dimension of entertainment, customization, and/or creativity to a user. While the plurality of plastically deformable members 122 have just been disclosed as comprising fingers on a portion of a character which includes a hand, alternative embodiments may include the plurality of plastically deformable members 122 comprising arms on a body, or any other appendage or shape related to or unrelated to a portion of a character or an entire character.

The writing tip of the writing instrument 100 depicted in FIGS. 6-8, although not shown includes a conventional ink cartridge contained within the body 112 and extends therefrom to enable a user to write messages, draw pictures, etc. In one embodiment, the writing tip is located at the second end 112b of the body 112 of the writing instrument 100, and is therefore disposed within the end cap 114. So configured, the end cap 114 would serve as a traditional pen cap to be removed when an individual desires to use the pen and replaced for storage. In an alternative embodiment, however, the writing tip may be located at the first end 112a of the body of the writing instrument 100, which is opposite to the end cap 114 and plastically deformable member 118. So configured, the writing instrument 100 may include a traditional pen cap removably disposed on the first end 112a and the end cap 114 and plastically deformable member 118 may be irremovably disposed on the second end 112b similar to the end cap 14 described above with reference to the embodiment depicted in FIGS. 1-3. Nevertheless, in either configuration, the plastically deformable member 18 may be manipulated and arranged between a plurality of configurations for entertaining oneself and/or storing, transporting, and/or displaying the writing instrument 100. Furthermore, in the embodiment depicted in FIGS. 8 and 9, the elements 122 of the character 120, which include fingers on a hand, may be arranged in a variety of configurations for entertaining and/or creatively expressing oneself.

In other embodiments of the writing instrument 10, 100, the secured end 118a is rotatably attached to the end cap 114 with a lock ring 130 similar to that described above with reference to FIG. 5. However, in alternative embodiments any other device or mechanism of attachment may be used. For example, FIGS. 10 and 11 depict the end cap 114 and one embodiment of a lock ring 130 securing the plastically deformable member 118 (or plurality of plastically deformable members) to the end cap 114. More specifically, the end cap 114 retains the lock ring 130, which retains the plastically deformable member 118, such that the plastically deformable member 118 (or plurality of plastically deformable members) is adapted for rotational displacement relative to the end cap 114.

The end cap 114 is similar to the end cap 14 described above with reference to FIG. 5 in that it comprises a generally hollow cylindrical member having an inner surface 123, an annular shoulder 124, and an orifice 126. The inner surface 123 defines a cavity 128. Additionally, however, the end cap 114 of the embodiment depicted in FIGS. 10 and 11 comprises a flange 125. The flange 125 is generally shaped as a cylinder and extends from the orifice 126 into the cavity 128. More specifically and with reference to FIG. 11, the flange 125 includes an inner bore 132 and a plurality of longitudinally extending slots 133, which traverse through the flange 125. The inner bore 132 comprises a small bore portion 134, a large bore portion 136, and a shoulder portion 138. The shoulder portion 138 is disposed between the small bore portion 134 and the large bore portion 136. The shoulder portion 138 comprises a shelf surface 140 and a chambered edge 142.

Referring back to FIG. 10 and as mentioned above, the lock ring 130 retains the secured end 118a of the plastically deformable member 118 (or plurality of plastically deformable members) for rotational displacement within the flange 125. More specifically, the lock ring 130 comprises a generally cylindrical body including a top portion 144 and a bottom portion 146. The top portion 144 includes a cylindrical cavity 148 and a radial flange 150 extending therefrom. The bottom portion 146 includes a shoulder 152, a nose 154, and a reduced diameter portion 156 disposed therebetween. Additionally, the bottom portion 146 defines a small bore 158 and a large bore 160. In the embodiment depicted in FIG. 10, the plastically deformable member 118 comprises a wire core 162 and a plastic coating 164. Accordingly, as depicted, the wire core 162 of the secured end 118a of the plastically deformable member 118 extends longitudinally beyond the plastic coating 164 and is coupled to a button 166, which has a diameter greater than the rest of the wire core 162. So configured, the cavity 148 in the top portion 144 of the lock ring 130 is sized and configured to retain a portion of the secured end 118a which comprises both the wire core 162 and the plastic coating 164. The plastic coating 164 prevents the plastically deformable member 118 from displacing into the cavity 128 of the end cap 114 relative to the lock ring 130. The small bore 158 in the bottom portion 146 of the lock ring 130 is sized and configured to retain the portion of the secured end 118a which comprises the wire core 162 extending beyond the plastic coating 164. The button 166 coupled to the wire core 162 is disposed in the large bore 160 in the bottom portion 146 of the lock ring 130. Accordingly, the button 166 prevents the secured end 118a of the plastically deformable member 118 from being removed from the lock ring 130. In one embodiment, the button 166 is an integral portion of the wire core 162 formed by compressing an end of the wire core 162 into the large bore 160 of the lock ring 130. In alternative embodiments, however, the button 166 may be a separate piece such as a nut, washer, or other device, secured to the wire core 162 to retain the secured end 118a of the plastically deformable member 118 to the lock ring 130. Additionally, in a preferred embodiment, an adhesive is disposed in the lock ring 130 to retain the plastically deformable member 118 therein. In one embodiment, the adhesive is disposed in at least one of the cylindrical cavity 148 of the top portion 144, the small bore 158 in the bottom portion 146, and the large bore 160 in the bottom portion 146 of the lock ring 130.

With continued reference to FIG. 10, the lock ring 130 is disposed to generally freely rotate within the end cap 114, thereby enabling rotation of the plastically deformable member 118 relative to the end cap 114. For example, a majority of the bottom portion 146 of the lock ring, 130 is disposed within the inner bore 132 of the flange 125 of the end cap 114. More specifically, the shoulder 152 of the lock ring 130 is disposed within the large bore portion 136 of the inner bore 132 of the flange 125 such that it axially engages the shelf surface 140, but remains capable of rotational movement. The nose 154 of the lock ring 130 is disposed within the cavity 128 of the end cap 114 below the flange 125. The nose 154 includes a diameter that is greater than a diameter of the inner bore 132 of the flange 125 of the end cap 114 such that the nose 154 prevents the lock ring 130 from being removed from the end cap 114. Thus, as depicted, the reduced diameter portion 156 of the lock ring 130 is disposed within the inner bore 132 of the flange 125. The reduced diameter portion 156 has a diameter that is sized less than a diameter of the inner bore 132, thereby enabling generally free rotation therein.

While the nose 154 of the lock ring 130 operates to prevent the lock ring 130 from being removed from the end cap 114, the radial flange 150 of the top portion 144 operates to prevent the lock ring 130 from falling into the cavity 128 of the end cap 114. More specifically, as depicted in FIG. 10, the radial flange 150 axially engages the annular shoulder 124 of the end cap 114 adjacent to the orifice 126, thereby axially locating lock ring 130 relative to the end cap 114 in conjunction with the nose 154.

Furthermore, as mentioned above, the flange 125 includes the chamfered edge 142 disposed between the small bore portion 134 and the large bore portion 136, as well as the plurality of slots 133. Additionally, the nose 154 includes a bull-nose surface 154a. It should therefore be appreciated that during assembly of the lock ring 130 to the end cap 114, lock ring 130 is inserted into the end cap 114 such that the bull-nose surface 154a of the nose 154 slidingly engages the chamfered edge 142. Subsequently, the nose 154 traverses the inner bore 132 to finally arrive at the configuration depicted in FIG. 10. While the nose 154 passes through the inner bore 132, the slots 133 enable the flange 125 to deflect radially outwardly. Upon the nose 154 passing the inner bore 132, the flange 125 resiliently returns to its natural position depicted in FIG. 10 to lock the lock ring 130 therein. Thus, it should be appreciated that in one embodiment, the lock ring 130 described with respect to FIG. 10 is capable of generally freely rotating 360° relative to the end cap 114, thereby maximizing the range of motion and minimizing the possibility of braking the plastically deformable member 118. In another embodiment, the secured end 118a of the plastically deformable member 118 disclosed with reference to FIGS. 10 and 11 may rotate relative to the lock ring 130 in addition to the lock ring 130 rotating relative to the end cap 114. Additionally, the rotation of the plastically deformable member 118 provides another dimension to which a user may entertain his/herself.

While the lock ring 130 and end cap 114 depicted in FIGS. 10 and 11 have been described herein as specifically adapted to retaining a single plastically deformable element 118 such as those described with reference to FIGS. 6-8, alternative embodiments may include the lock ring 130 and end cap 114 depicted in FIGS. 10 and 11 securing a plurality of plastically deformable members 18 such as those described with reference to FIGS. 1-5. Accordingly, the lock ring 130 and end cap 114 arrangement depicted and described with reference to FIGS. 10 and 11 is not limited to a single plastically deformable member 118, but may also be implemented to retain a plurality of plastically deformable members.

Although FIGS. 5 and 10 illustrate the end caps 14, 114 as defining cavities 28, 128 generally sized and configured to accommodate the lock rings 30, 130 and the secured ends 18a, 118a of the plastically deformable members 18, 118, alternative embodiments may comprise much larger cavities 28, 128 in proportion to the lock rings 30, 130. Such enlarged cavities 28, 128 could be adapted to allow the plastically deformable members 18, 118 to slide in and out of the cavities 28, 128, thus temporarily receiving and storing at least a portion of the free ends 18b, 118b in addition to the lock rings 30, 130 and the secured ends 18a, 118a. If such a configuration is adopted in conjunction with a writing instrument 10 which includes a design 20 comprising a monkey's face disposed on the body 12 such as that depicted in FIGS. 1-3, a user could pull the stored portion of the plastically deformable members 18, 118 out of the cavities 28, 128 to create the illusion that the hair on the monkey's head is growing.

Still further, while the end caps 14, 114 and plastically deformable members 18, 118 have been described herein as being associated with a single writing instrument 10, 100, an alternative embodiment includes an accessory to a writing instrument 10, 100 that comprises an end cap 14, 114 and one or more plastically deformable members 18, 118. Such an accessory cap may be acquired by a user and incorporated with any type of writing instrument including pens, pencils, markers, etc. Thus, such an accessory cap could provide an individual with the ability to customize any writing instrument or at least add a degree of entertainment and/or creativity to any writing instrument, as well as utilize the accessory as a mechanism to easily attach a writing instrument to an article such as a book bag, notebook, or any other such article.

Furthermore, while the plastically deformable members 18, 118, 122 have been described herein as comprising metal wires coated with plastic, alternate embodiments may comprise, as mentioned above, purely plastic members, purely metal members, metal wires coated in rubber, metal wires coated in fabric, or any other material coated in plastic, rubber, or fabric, or any other material capable of being configured in the ways described herein. In other embodiments, however, the plastically deformable members 18, 118, 122 may comprise metal wires coated with rubber, woven fabric, or any other material. Thus, the plastically deformable members 18, 118, 122, as described herein, are not limited to coated metal wires, plastic wires, or any particular material, but may include any material capable of serving the principles of the present disclosure.

Further still, while the plurality of plastically deformable members 18 described herein with reference to FIGS. 1-5 may be constructed of the same length, as mentioned above, in alternative embodiments, the plurality of deformable members 18 may be constructed of varying lengths. Such varying lengths provide an additional way to customize the writing instrument and for a user to express his/her creativity.

Therefore, in light of the foregoing, it should be appreciated that the present invention is not limited to the examples and embodiments disclosed herein, but is defined by the spirit and scope of the claims.

What is claimed:

1. A writing instrument, comprising:
a body containing a writing medium;
a writing tip extending from the body; and
at least one plastically deformable member extending from the body, the at least one plastically deformable member adapted to be arranged in a plurality of different configurations.

2. The writing instrument of claim 1, wherein the body further comprises a cap such that the at least one plastically deformable member extends from the cap.

3. The writing instrument of claim 1, wherein the at least one plastically deformable member comprises a plurality of plastically deformable members of substantially equal length.

4. The writing instrument of claim 1, wherein the at least one plastically deformable member comprises a wire member coated in plastic.

5. The writing instrument of claim 1, further comprising a design provided on the body of the writing instrument.

6. The writing instrument of claim 15 further comprising a design provided on the at least one plastically deformable member.

7. The accessory of claim 1, further comprising at least a portion of a character provided on the body such that the at least one plastically deformable member comprises a characteristic of the character.

8. The accessory of claim 7, wherein the at least one plastically deformable member comprises hair of the character.

9. The writing instrument of claim 1, further comprising a plurality of additional plastically deformable members extending from the at least one plastically deformable member.

10. The writing instrument of claim 1, wherein the at least one plastically deformable member is adapted to be secured to an article.

11. The writing instrument of claim 1, wherein the at least one plastically deformable member is rotatably secured to the body.

12. A writing instrument, comprising:
a body containing a writing medium
a writing tip extending from the body; and
at least a portion of a character comprising a first portion disposed on the body and a second portion extending from the body, the second portion comprising a plurality of plastically deformable members adapted to be manipulated between a plurality of configurations to thereby alter the appearance of the character.

13. The writing instrument of claim 12, wherein the first portion of the character comprises a face of the character and the second portion comprises hair.

14. The writing instrument of claim 12 wherein the plurality of plastically deformable members are substantially equal in length.

15. The writing instrument of claim 12, wherein the plurality of plastically deformable members comprise wire members coated in plastic.

16. The writing instrument of claim 12, wherein the plurality of plastically deformable members are rotatably secured to the body.

17. An accessory for a writing instrument, the accessory comprising:
a cap adapted to be removably attached to a writing instrument; and
at least one plastically deformable member attached to the cap and adapted to be bent into a plurality of configurations to customize the appearance of the writing instrument.

18. The accessory of claim 17, wherein the at least one plastically deformable member comprises a wire member coated in plastic.

19. The accessory of claim 17, further comprising a design provided on the cap.

20. The accessory of claim 17, further comprising a design provided on the at least one plastically deformable member.

21. The accessory of claim 17, wherein the at least one plastically deformable member is attached to the cap for rotational displacement.

22. The accessory of claim 17, further comprising at least a portion of a character provided on the cap such that the at least one plastically deformable member comprises a characteristic of the character.

23. The accessory of claim 22, wherein the characteristic of the character comprises hair of the character.
